(19) United States
(12) Patent Application Publication
(10) Pub. No.: US 2005/0273327 A1
(43) Pub. Date: Dec. 8, 2005

(54) Mobile station and method for transmitting and receiving messages

(75) Inventor: Arjun Krishnan, Plano, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/858,578

(22) Filed: Jun. 2, 2004

(51) Int. Cl. G10L 15/26

(52) U.S. Cl. 704/235

(57) ABSTRACT

Mobile stations and methods are provided for transmitting and/or receiving messages. The mobile station includes a controller capable of operating a phoneme engine, which is capable of receiving a message comprising input speech. Thereafter, the phoneme engine can convert the input speech into at least one phoneme representative of the input speech. The mobile station also includes a transmitter capable of transmitting a representation of the input speech, where the representation is based upon the phonemes. The mobile station may include a receiver capable of receiving a representation of a speech-based message, where the representation is based upon at least one phoneme. The mobile station also includes the controller capable of operating a phoneme engine, which in such instances, is capable of converting the phonemes into the speech-based message. The mobile station in such instances also includes a speaker capable of thereafter outputting the speech-based message.

### FIELD

The present invention relates generally to mobile stations and methods for transmitting and receiving messages, and more particularly, relates to mobile stations and methods for transmitting and receiving messages comprising representations of speech, including phonemes and/or shorthand text.

### BACKGROUND

In many voice communication systems, users communicate with one another over voice channels. More particularly, in such voice communication systems, users communicate with one another in real-time by opening and maintaining voice channels between the users. As will be appreciated, however, in various instances one user may desire to communicate with another user who may be unavailable. In such instances, the user may communicate with the other user nonetheless by transmitting a voice message, which may thereafter be received by the unavailable user. Even in these instances, however, the voice message is transmitted to the unavailable user in real-time as the message is transmitted directly to the unavailable user or to an intermediary, such as a message center, as the user communicates the message.

As will be appreciated by those skilled in the art, the real-time transfer of voice communications over voice channels, whether directly communicating to another user or transmitting a voice message, can require an undesirable amount of bandwidth. As will also be appreciated, in various instances users desire to communicate with other users, but are not concerned with whether the communication is in real time. For example, users may communicate with other users over text communication systems via email, SMS or the like in non-real time whereby the users may compose and edit text communications before transmitting the same to the other users, either directly or indirectly. Text communication systems allow users to communicate with one another in non-real time, and require less bandwidth than real-time communication over voice communication systems. However, text communication systems provide an amount of inconvenience to users as users must typically type text messages on a keypad or the like. In this regard, in the case of mobile communication systems, the inconvenience is heightened by the fact that the keypads can be quite small. Also, in addition to the inconvenience, requiring users to compose such text messages increases the likelihood of errors in such messages, such as may be incurred as the messages are composed and/or edited.

To overcome the drawbacks of the prior voice and text communication techniques, systems have been developed that provide the convenience of real-time voice communication, with the bandwidth advantages of non-real time text communication. One such system is disclosed by U.S. Pat. No. 6,366,651, entitled: Communication Device Having Capability to Convert Between Voice and Text Message, issued Apr. 2, 2002 to Griffith et al. (hereinafter referred to as “the '651 patent”). As disclosed, the system of the '651 patent is capable of receiving a voice input communication from a calling party. The system can automatically convert the voice input to a text message, which can thereafter be displayed and transmitted to a called party. Once received by the called party, the text message can thereafter be converted back into voice.

Whereas systems such as that disclosed by the '651 patent overcome many of the drawbacks of prior communication systems, such systems have additional drawbacks. Such systems require a communication device of each user, such as a mobile station of each user, to perform the conversion of a voice message into a text message, and vice versa. In this regard, the conversion of voice to text and vice versa can require an undesirable amount of computing resources for each communication device. Also, as communication devices such as mobile stations include a limited amount of computing resources due to the size of such devices, requiring mobile stations to convert a voice message into text and vice versa can place an undesirable burden on such devices, thereby requiring the devices to operate at a significantly reduced efficiency.

### SUMMARY

In light of the foregoing background, embodiments of the present invention provide improved mobile stations and methods for transmitting and receiving messages. According to embodiments of the present invention, the messages are representative of input speech and may comprise phonemes and/or shorthand text (e.g., Internet shorthand text). By transmitting and receiving messages that comprise phonemes and/or shorthand text, but are representative of input speech, embodiments of the present invention are capable of transmitting and receiving the messages while consuming less bandwidth than in instances of transmitting and receiving input speech. Also, by transmitting representations of the input speech comprising phonemes and/or shorthand text, as opposed to the longhand text of conventional speech-to-text and text-to-speech converters, embodiments of the present invention are capable of transmitting and receiving messages requiring less computational resources.

According to one aspect of the present invention, a mobile station for transmitting and/or receiving messages is provided. The mobile station includes a controller capable of operating a phoneme engine. In turn, the phoneme engine is capable of receiving a message comprising input speech, and thereafter converting the input speech into at least one phoneme representative of the input speech. The mobile station also includes a transmitter capable of transmitting a representation of the input speech, such as to other mobile stations, processing elements or the like. The representation of the input speech is based upon the phonemes. In this regard, the representation may comprise the phonemes, or alternatively, shorthand text.

The phoneme engine may also be capable of converting the phonemes into shorthand text representative of the input speech, such as Internet shorthand. In such instances, the transmitter may be capable of transmitting a representation of the input speech comprising the shorthand text. Also in such instances, the controller may be capable of operating a software application to train the phoneme engine to associate phonemes with predetermined shorthand text. Further, the mobile station may also include a display capable of presenting the shorthand text to facilitate confirmation of the conversion, such as before the transmitter transmits the representation of the input speech.

According to another aspect of the present invention, the mobile station includes a receiver capable of receiving a representation of a speech-based message, such as from another mobile station, a processing element or the like. The representation of a speech-based message is based upon at least one phoneme. The mobile station also includes the controller capable of operating a phoneme engine. In this regard, the phoneme engine is capable of converting the phonemes representative of speech-based message into the speech-based message. The mobile station also includes a speaker capable of thereafter outputting the speech-based message, such as to a user of the mobile station. The receiver of the mobile station may be capable of receiving a representation of a speech-based message comprising shorthand text, such as Internet shorthand, representative of speech-based message. In such instances, the phoneme engine is capable of converting the shorthand text into at least one phoneme representative of the speech-based message before converting the phonemes. The mobile station may also include a display for presenting the shorthand text after the receiver receives the speech-based message.

Methods for transmitting and receiving messages are also provided. Thus, embodiments of the present invention provide mobile stations and methods for transmitting and/or receiving messages. As indicated, according to embodiments of the present invention, the messages are representative of input speech and may comprise phonemes and/or shorthand text (e.g., Internet shorthand text). The mobile stations and methods of embodiments of the present invention are capable of transmitting messages representative of input speech while consuming less bandwidth than conventional mobile stations and methods that transmit and receive the input speech. In addition, the mobile stations and methods of embodiments of the present invention are capable of transmitting messages comprising phonemes and/or shorthand text while requiring less computational resources than conventional mobile stations and methods of transmitting messages comprising longhand text. Therefore, the systems and methods of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which the mobile station is bi-directionally coupled through wireless RF links;

FIG. 2 is a schematic block diagram of a mobile station according to one embodiment of the present invention;

FIG. 3 is a chart of the International Phonetic Alphabet of the International Phonetic Association;

FIG. 4 is a flow chart of a method of transmitting a message according to one embodiment of the present invention; and

FIG. 5 is a flow chart of a method of receiving a message according to one embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

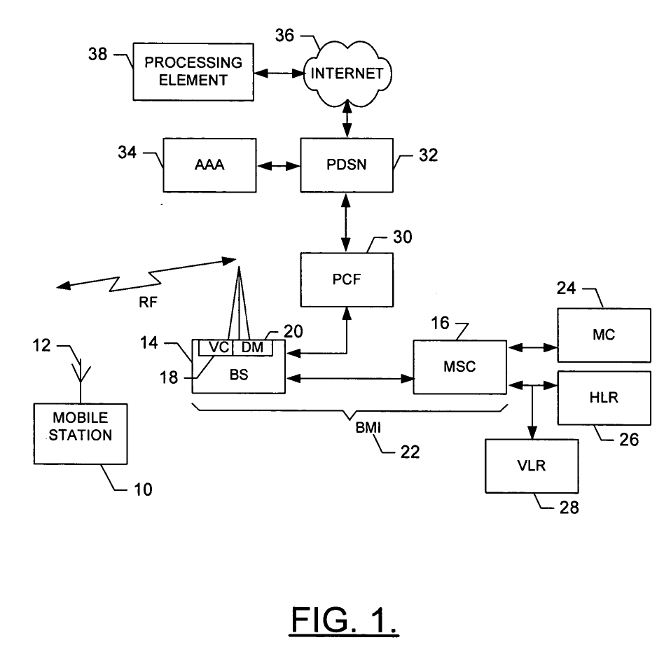

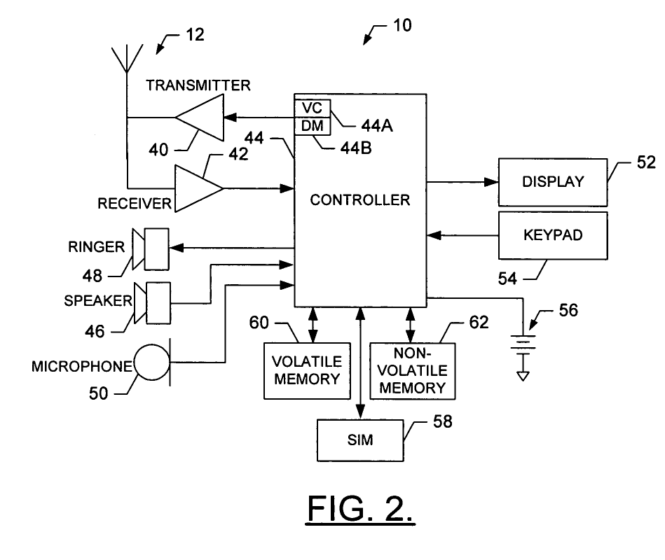

Referring to FIGS. 1 and 2, an illustration of one type of wireless communications network including a terminal, such as a mobile station 10, that would benefit from the present invention is provided. It should be understood, however, that the mobile telephone illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention. In addition, while several embodiments of the system and method of the present invention include a terminal comprising a mobile station 10, the terminal need not comprise a mobile station. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

As shown, the mobile station 10 includes an antenna 12 for transmitting signals to and for receiving signals from a base site or base station (BS) 14. The base station is a part of a cellular network that includes a mobile switching center (MSC) 16, voice coder/decoders (vocoders) (VC) 18, data modems (DM) 20, and other units required to operate the network. The MSC is capable of routing calls and messages to and from the mobile station when the mobile station is making and receiving calls. As indicated above, the cellular network may also be referred to as a Base Station/MSC/Interworking function (BMI) 22. The MSC controls the forwarding of messages to and from the mobile station when the station is registered with the network, and also controls the forwarding of messages for the mobile station to and from a message center 24. Such messages may include, for example, voice messages received by the MSC from users of Public Switched Telephone Network (PSTN) telephones, and may also include Short Message Service (SMS) messages and voice messages received by the MSC from the mobile station or other mobile terminals serviced by the network.

Subscriber data of a mobile station 10 is stored permanently in a Home Location Register (HLR) 26 of the system and temporarily in the Visitor Location Register (VLR) 28 in the area of which the mobile station is located at a given moment. In this regard, the VLR contains selected administrative information necessary for call control and provision of the subscribed services for each mobile station currently located in the geographical area controlled by the VLR. Although each functional entity can be implemented as an independent unit, manufacturers of switching equipment generally implement the VLR together with the MSC 16 so that the geographical area controlled by the MSC corresponds to that controlled by the VLR, thus simplifying the signaling required. As such, the MSC and VLR will collectively be referred to herein as the MSC/VLR.

The mobile station 10 can also be coupled to a data network. For example, the BS 14 can be connected to a packet control function (PCF) 30, which is in connection with a Packet Data Serving Node (PDSN) 32. The PDSN is preferably connected to an AAA server 34, which provides Authentication, Authorization, and Accounting services. The AAA server can comprise a Remote Access Dialup User Service (RADIUS) server, as will be appreciated by those skilled in the art. The PDSN can also be connected to a wide area network, such as the Internet 36. In turn, devices such as processing elements 38 (e.g., personal computers, server computers or the like) can be coupled to the mobile station via the PDSN. By directly or indirectly connecting both the mobile station and the other devices to the PDSN and the Internet, the mobile station can communicate with the other devices, such as according to the Internet Protocol (IP) specification, to thereby carry out various functions of the mobile station.

Reference is now drawn to FIG. 2, which illustrates a block diagram of a mobile station 10 that would benefit from the present invention. The mobile station includes a transmitter 40, a receiver 42, and a controller 44 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first, second and/or third-generation communication protocols or the like. For example, the mobile station may be capable of operating in accordance with second-generation (2G) wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 44 includes the circuitry required for implementing the audio and logic functions of the mobile station 10. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 44A, and may include an internal data modem (DM) 44B. Further, the controller 44 may include the functionally to operate one or more software programs, which may be stored in memory. For example, the controller may be capable of operating a connectivity program, such as a conventional Web browser.

The mobile station 10 also comprises a user interface including a conventional earphone or speaker 46, a ringer 48, a microphone 50, a display 52, and a user input interface, all of which are coupled to the controller 44. The user input interface, which allows the mobile station to receive data, can comprise any of a number of devices allowing the mobile station to receive data, such as a keypad 54, a touch display (not shown) or other input device. In embodiments including a keypad, the keypad includes the conventional numeric (0-9) and related keys (#, *), and other keys used for operating the mobile station.

The mobile station further includes a battery 56, such as a vibrating battery pack, for powering the various circuits that are required to operate the mobile station, as well as optionally providing mechanical vibration as a detectable output. The mobile station 10 can also include memory, such as a subscriber identity module (SIM) 58, a removable user identity module (R-UIM) or the like, which typically stores information elements related to a mobile subscriber. In addition to the SIM, the mobile station can include other memory. In this regard, the mobile station can include volatile memory 60, such as volatile Random Access Memory (RAM) including a cache area for the temporary storage of data. The mobile station can also include other non-volatile memory 62, which can be embedded and/or may be removable. The non-volatile memory can additionally or alternatively comprise an EEPROM, flash memory or the like. The memories can store any of a number of pieces of information, and data, used by the mobile station to implement the functions of the mobile station. For example, the memories can include an identifier, such as an international mobile equipment identification (IMEI) code, capable of uniquely identifying the mobile station, such as to the MSC 16.

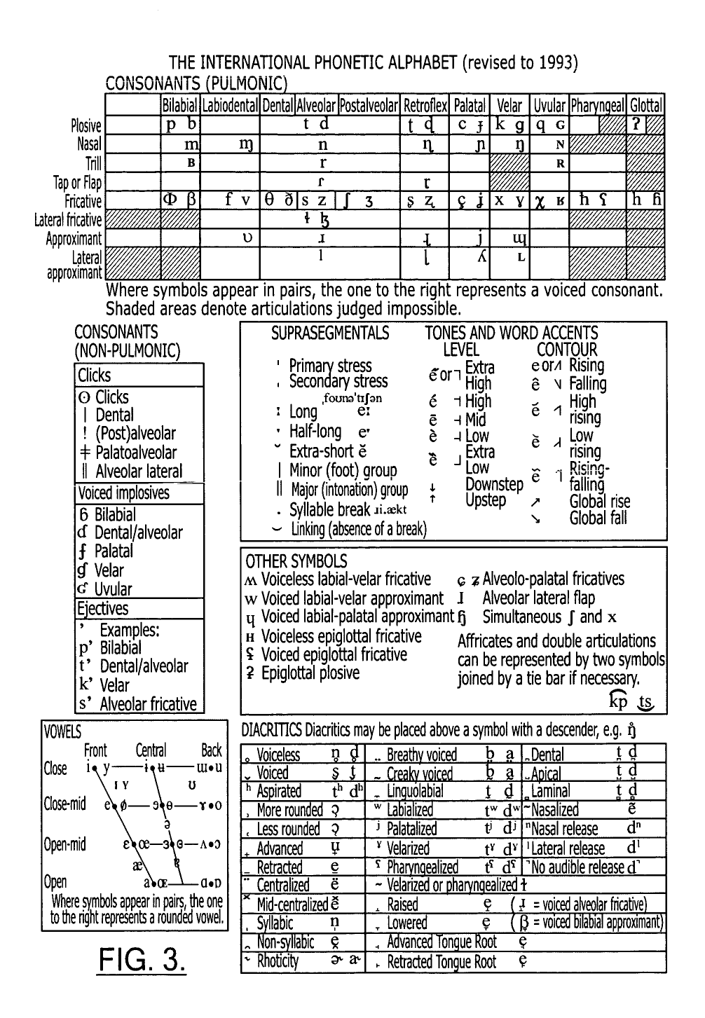

According to embodiments of the present invention, the controller 44 is capable of operating a speech phoneme engine, typically of relatively low complexity. The phoneme engine is capable of receiving input speech from a user of the mobile station, such as via the microphone 50, and thereafter converting the input speech into a series of phonemes representative of the input speech. As known to those skilled in the art, phonemes are generally defined as a set of symbols that correspond to a set of similar speech sounds, which are perceived to be a single distinctive sound. The phoneme engine can convert the input speech into any of a number of known symbols (i.e., phonemes) representative of the input speech, and can convert the input speech into those symbols in accordance with any of a number of known techniques. In one advantageous embodiment, for example, the input speech can be converted to phonemes in the International Phonetic Alphabet of the International Phonetic Association (as shown in FIG. 3) in accordance with any of a number of different phonetic transcription techniques, as such are well known to those skilled in the art.

In addition to operating the phoneme engine, the controller 44 of embodiments of the present invention is capable of presenting, such as on the display 52, a representation of the input speech. In this regard, once the phoneme engine has converted the input speech to phonemes, the controller can present the phonemes on the display. As will be appreciated, however, in many instances a user of the mobile station 10 will not be capable of comprehending a display of phonemes. Therefore, the phoneme engine of embodiments of the present invention may also be capable of further converting the phonemes into text that may be better understood by the user. In one embodiment the phoneme engine is capable of converting the phonemes into longhand text in a specified language. As will be appreciated, however, in various instances it may be desirable to reduce the amount of resources required by the controller to convert the phonemes into text. According to one advantageous embodiment, then, the phoneme engine is capable of further converting the phonemes into shorthand text.

The phoneme engine is capable of converting the phonemes into shorthand text according to any of a number of different techniques. For example, according to one technique, the mobile station 10 may maintain a table of shorthand words and phrases and associated phonemes or series of phonemes. To convert the phonemes into shorthand text, then, the phoneme engine may perform a table lookup to find the shorthand text associated with a respective phoneme or set of phonemes. Additionally, or alternatively, the phoneme engine may be capable of performing a technique for converting the phonemes into shorthand text, such as for all of the phonemes or for those phonemes that are not otherwise associated with shorthand text located in the table of shorthand words and phrases. The phoneme engine may be capable of performing any of a number of known techniques for converting the phonemes into shorthand text.

The mobile station 10 may have stored a table of shorthand words and phrases and associated phonemes. Alternatively, the mobile station may be capable of operating a software application that leads a user of the mobile station through a series of steps to “train” the mobile station to associate phonemes, or more particularly spoken words and phrases, with predetermined shorthand text. In this regard, the mobile station may lead the user through a series of steps to fill in the table of phonemes and associated shorthand words and phrases, where the user speaks a word or phrase and enters, such as via the keypad 54, the associated shorthand text. The phoneme engine can then receive the speech input and convert the speech input into phonemes, with the controller subsequently associating the phonemes with the shorthand text entered by the user.

The shorthand text can comprise any of a number of different words, phrases, acronyms or the like capable of being understood by a user as representing other words, phrases, acronyms or the like. For example, over the past few years a type of shorthand, often referred to as Internet shorthand, has developed. As will be appreciated by those skilled in the art, such shorthand is often used when “texting” other users via email, Internet chatrooms, SMS and the like. For a non-exhaustive listing of a number of such words and phrases, and their associated Internet shorthand, see Table 1 below.

TABLE 1

| Word or Phrase | Internet Shorthand |
|---|---|
| To, Too, Two | 2 |
| For, Four | 4 |
| As far as I know | AFAIK |
| As soon as possible | ASAP |
| Before | B4 |
| Best Regards | BR |
| By all means | BAM |
| By the way | BTW |
| Consider it done | CID |
| See you later | CUL8R |
| Disregard last transmission | DLT |
| Email you later | EMYL |
| From bad to worse | FBTW |
| Foot in mouth | FIM |
| Face to face | F2F |
| Far out! | FO |
| Farewell for now | FWFN |
| For your amusement | FYA |
| For your information | FYI |
| For what it's worth | FWIW |
| Great | GR8 |
| Have a nice day | HAND |
| How are you? | HAY |
| I'll be late | ILBL8 |
| In my humble opinion | IMHO |
| In my opinion | IMO |
| Know what I mean? | KWIM |
| Later | L8R |
| Lowest common denominator | LCD |
| Let me know | LMK |
| Laughing out loud | LOL |
| Message | MSG |
| Not available | NA |
| Not a problem | NAP |
| Oh, by the way | OBTW |
| Oh, I see | OIC |
| Oh, my God | OMG |
| Out of luck | OOL |
| Please call me | PCM |
| Password | PW |
| Are | R |
| Rolling on floor laughing | ROFL |
| Are you free to talk? | RUF2T |
| Are you OK? | RUOK |
| Thanks | THX |
| Thanks in advance | TIA |
| Thanks | TNX |
| Thinking of you | TOY |
| Talk to you later | TTYL |
| Tonight | 2NITE |
| You | U |
| With respect to | WRT |
| Way to go! | WTG |
| Excellent | XLNT |
| You had to be there | YHTBT |

With the phonemes and/or shorthand text, the mobile station 10 is capable of transmitting the phonemes and/or shorthand text, such as to other mobile stations, processing elements 38 or the like. Similarly, then, the mobile station may be capable of receiving phonemes and/or shorthand text, such as from other mobile stations, processing elements or the like. The phonemes and/or shorthand text can be transmitted and received in any of a number of different manners, such as according to a technique for transmitting and receiving SMS messages. In this regard, by transmitting and receiving phonemes and/or shorthand text, as opposed to voice or longhand text, the mobile station of embodiments of the present invention is capable of transmitting and receiving information in a manner requiring less bandwidth and computational resources.

In addition to converting input speech into phonemes, and converting phonemes into shorthand text, the phoneme engine operated by the controller 44 of the mobile station 10 may also be capable of receiving phonemes and converting the phonemes into output speech representative of the phonemes. Additionally, the phoneme engine may be capable of receiving shorthand text and converting the shorthand text into phonemes, which may thereafter be converted into output speech. The phoneme engine can be capable of converting phonemes into output speech according to any of a number of different voice synthesis techniques, as such are well known to those skilled in the art. Likewise, the phoneme engine can be capable of converting shorthand text into phonemes according to any of a number of different techniques, such as by using a lookup table in a reverse manner as described above for converting phonemes into shorthand text.

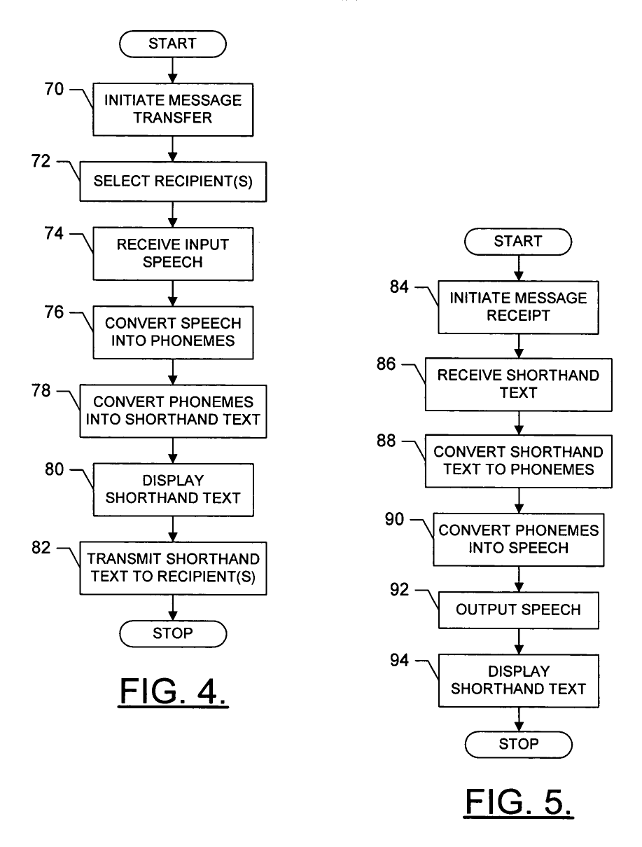

Referring now to FIG. 4, according to one embodiment of the present invention, a method of transmitting a message may be initiated by a user of the mobile station 10, such as by selecting an appropriate function on the mobile station, as shown in block 70. The user may then select one or more recipients of the message, as shown in block 72. The recipients may be selected in any of a number of different manners, such as by entering an identifier, such as an SMS number or IP address associated with each recipient. Alternatively, the recipients may be selected from an electronic address book maintained by the mobile station. As will be appreciated, although the recipients are described as being selected after initiating the message transfer, the recipients may be selected at any point prior to transmitting the message, without departing from the spirit and scope of the present invention.

After selecting the recipients, the mobile station 10 may present the user with a prompt to enter a voice message, which the mobile station then receives as input speech, as shown in block 74. For example, presume that John desires to transfer a message to the user of another mobile station, Mark. After being prompted for the message, then, John can enter the message, “Hi Mark. Are you free to talk tonight. Let me know,” by speaking into the microphone 50 of the mobile station. After receiving the input speech, the input speech is passed to the phoneme engine operated by the controller 44. The phoneme engine can thereafter convert the input speech into phonemes, as illustrated in block 76. Once the phoneme engine has converted the input speech into phonemes, the phoneme engine can further convert the phonemes into shorthand text, such as by utilizing a lookup table and/or other technique for converting the phonemes into shorthand text, as described above and shown in block 78 of FIG. 4. In the example given above, the phoneme engine can convert the message “Hi Mark. Are you free to talk to night. Let me know,” into the shorthand “Hi Mark. RUF2T 2NITE LMK.” After converting the phonemes into shorthand text, the controller may direct the display 52 of the mobile station to present the shorthand text, as illustrated in block 80. In this manner, the user of the mobile station may confirm proper conversion of the input speech into phonemes, and thereafter to the shorthand text.

After displaying the shorthand text, and after the user has confirmed proper conversion of the input speech and/or edited the shorthand text, if so desired, the mobile station 10 may transmit the shorthand text message to the selected recipients, as shown in block 82. The shorthand text message may be transmitted in any of a number of different manners. In one embodiment, for example, the shorthand text message may be formatted as an SMS message, and thereafter transmitted according to a technique for transmitting SMS messages. As will be appreciated, the shorthand text message may be transmitted directly the recipients. Alternatively, the shorthand text message may be transmitted indirectly to one or more of the recipients, such as by being transmitted to a message center 24, from which the respective recipients may download or otherwise retrieve the shorthand text message.

Referring now to FIG. 5, a method of receiving a shorthand text message according to one embodiment of the present invention begins by initiating receipt of the shorthand text message, such as by selecting an appropriate function on the mobile station 10, as shown in block 84. If the shorthand text message has been transmitted indirectly to the mobile station, such as to a message center 24, the mobile station may thereafter receive the shorthand text from the message center, and pass the shorthand text message to the phoneme engine operated by the controller 44. Otherwise, the mobile station may have directly received the shorthand text message and stored the message in memory, such as non-volatile memory 62. In such instances, the phoneme engine may receive the shorthand text message from memory.

Upon receipt of the shorthand text message, the phoneme engine can convert the shorthand text into phonemes, such as by utilizing a lookup table and/or other technique for converting the shorthand text into phonemes, as described above and shown in block 88 of FIG. 5. After converting the shorthand text into phonemes, the phoneme engine can further convert the phonemes into speech output, as shown in block 90. The phoneme engine can convert the phonemes into speech output according to any of a number of different techniques. After the phoneme engine has converted the phonemes into output speech, the controller 44 can output the speech, such as via the speaker 46. In the example above, presume that Mark has received the shorthand text message, “Hi Mark. RUF2T 2NITE LMK.” In such an instance, the output may comprise speech reciting the message, “Hi Mark. Are you free to talk tonight. Let me know.” In addition to, or in lieu of, outputting speech representative of the shorthand text message, the mobile station 10 may present the shorthand text message, such as on the display 52, as shown in block 94. As will be appreciated by those skilled in the art, although the shorthand text has been described as being presented after outputting the speech representative of the message, the shorthand message may be presented on the display at any point after receiving the shorthand message, without departing from the spirit and scope of the present invention.

The preceding method of FIG. 4 has been described as including converting phonemes into shorthand text, displaying the shorthand text, and thereafter transmitting the shorthand text. Likewise, the method of FIG. 5 has been described as including receiving the shorthand text, converting the shorthand text into phonemes, and displaying the shorthand text. As will be appreciated, as both the phonemes and shorthand text are representative of the input speech, the shorthand text need not be utilized, particularly in instances in which neither mobile station displays the shorthand text message. In such instances, a method of transmitting such a message may include converting the input speech into phonemes, and thereafter transmitting the phonemes (with or without displaying the phonemes). Similarly, a method of receiving such a message may include receiving phonemes, converting the phonemes into speech, and thereafter outputting the speech (with or without displaying the phonemes). By transmitting and/or receiving the message as phonemes, as opposed to shorthand text, even less computational resources may be required as the phonemes are not converted to shorthand text and vice versa.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of transmitting a message comprising:
receiving a message comprising input speech;
converting the input speech into at least one phoneme representative of the input speech; and
transmitting a representation of the input speech, wherein the representation is based upon the at least one phoneme.

2. A method according to claim 1 further comprising:
converting the at least one phoneme into shorthand text representative of the input speech, wherein transmitting a representation of the input speech comprises transmitting the shorthand text representative of the input speech.

3. A method according to claim 2, wherein converting the at least one phoneme comprises at least partially converting the at least one phoneme into Internet shorthand text.

4. A method according to claim 2 further comprising:
displaying shorthand text to facilitate confirmation of the conversion before transmitting the shorthand text.

5. A method according to claim 2 further comprising:
training a phoneme engine to associate phonemes with predetermined shorthand text before converting the at least one phoneme into shorthand text.

6. A method of receiving a message comprising:
receiving a representation of a speech-based message, wherein the representation is based upon at least one phoneme;
converting the at least one phoneme into the speech-based message; and
outputting the speech-based message.

7. A method according to claim 6, wherein receiving a representation of a speech-based message comprises receiving a representation of a speech-based message comprising shorthand text representative of the speech-based message, the method further comprising:
converting the shorthand text into at least one phoneme representative of the speech-based message before converting the at least one phoneme.

8. A method according to claim 7, wherein receiving a representation of a speech-based message comprises receiving a representation of a speech-based message comprising Internet shorthand text representative of the speech-based message.

9. A method according to claim 7 further comprising displaying the shorthand text after receiving the representation of a speech-based message.

10. A method according to claim 7 further comprising:
training a phoneme engine to associate phonemes with predetermined shorthand text before converting the shorthand text into at least one phoneme.

11. A mobile station comprising:
a controller capable of operating a phoneme engine, wherein the phoneme engine is capable of receiving a message comprising input speech, and thereafter converting the input speech into at least one phoneme representative of the input speech; and
a transmitter capable of transmitting a representation of the input speech, wherein the representation is based upon the at least one phoneme.

12. A mobile station according to claim 11, wherein the phoneme engine is also capable of converting the at least one phoneme into shorthand text representative of the input speech, and wherein the transmitter is capable of transmitting the shorthand text representative of the input speech.

13. A mobile station according to claim 12, wherein the phoneme engine is capable of at least partially converting the at least one phoneme into Internet shorthand text.

14. A mobile station according to claim 12 further comprising:
a display capable of presenting the shorthand text to facilitate confirmation of the conversion.

15. A mobile station according to claim 12, wherein the controller is also capable of operating a software application to train the phoneme engine to associate phonemes with predetermined shorthand text.

16. A mobile station according to claim 11 further comprising:
a receiver capable of receiving a representation of a speech-based message, wherein the representation of a speech-based message comprises at least one phoneme, wherein the phoneme engine is capable of converting the at least one phoneme into the speech-based message; and
a speaker capable of outputting the speech-based message.

17. A mobile station comprising:
a receiver capable of receiving a representation of a speech-based message, wherein the representation is based upon at least one phoneme;
a controller capable of operating a phoneme engine, wherein the phoneme engine is capable of converting the at least one phoneme representative of speech into the speech-based message; and
a speaker capable of outputting the speech-based message.

18. A mobile station according to claim 17, wherein the receiver is capable of receiving a representation of a speech-based message comprising shorthand text representative of the speech-based message, wherein the phoneme engine is capable of converting the shorthand text into at least one phoneme representative of the speech-based message before converting the at least one phoneme.

19. A mobile station according to claim 18, wherein the receiver is capable of receiving a representation of a speech-based message comprising Internet shorthand text representative of the speech-based message.

20. A mobile station according to claim 18 further comprising:
a display capable of presenting the shorthand text after the receiver receives the representation of the speech-based message.

21. A mobile station according to claim 18, wherein the controller is also capable of operating a software application to train the phoneme engine to associate phonemes with predetermined shorthand text.

22. A mobile station according to claim 17, wherein the phoneme engine is capable of receiving a message comprising input speech, and thereafter converting the input speech into at least one phoneme representative of the input speech, and wherein the mobile station further comprises:
a transmitter capable of transmitting a representation of the input speech, wherein the representation is based upon the at least one phoneme.
